(19) United States
(12) Patent Application Publication
(10) Pub. No.: US 2026/0307431 A1
(43) Pub. Date: Oct. 8, 2026

(54) TENT SUPPORT TUBE CASTER DEVICE

(71) Applicant: Heshan Fengzhida Outdoor Products Co., Ltd, Jiangmen City (CN)

(72) Inventors: Zisheng Huang, Foshan City (CN); Huanming Huang, Foshan City (CN)

(21) Appl. No.: 19/220,103

(22) Filed: May 28, 2025

(30) Foreign Application Priority Data
Apr. 3, 2025 (CN) 2025104165514

(51) Int. Cl. B60B 33/00; E04H 15/34

(52) U.S. Cl. CPC B60B 33/001; B60B 33/0028; B60B 33/0039; B60B 33/0049; B60B 33/0063; E04H 15/34; B60B 2900/115; B60B 2900/531; B60B 2900/541

(57) ABSTRACT

This invention is a tent support tube caster device, including a base and a caster mechanism, in which the base is mounted at a bottom of a tent support tube, the caster mechanism includes a caster bracket and a roller mounted on the caster bracket, the roller is disposed at a lateral side of the base, and the caster mechanism is connected to the base. A positioning connection groove is formed at a bottom of the base, and the caster bracket is provided with a positioning connection block corresponding to the positioning connection groove. The present disclosure features a simple structure and facilitates easy and quick installation. During packaging, as the caster mechanism is only installed during use, it avoids puncture damage to cartons during transportation.

### CROSS REFERENCE TO RELATED APPLICATIONS

The present disclosure claims the priority of Chinese Patent Application No. 2025104165514 filed on Apr. 3, 2025. All the above are hereby incorporated by reference in their entirety.

### TECHNICAL FIELD

The present disclosure relates to the technical field of tents, specifically to a tent support tube caster device.

### BACKGROUND

With the improvement of living standards, people engage in increasingly frequent outdoor activities. Outdoor tents are commonly used in activities such as camping. An outdoor tent is a shelter erected on outdoor ground for temporary activities or habitation. The demand for outdoor tents continues to grow due to their advantages of flexible foldability and portability. The structural composition of an outdoor tent generally includes canvas (i.e., tent fabric) and a foldable support frame that supports the canvas. The foldable support frame is provided with support tubes, which are used to stabilize the tent on the ground during use. However, during the process of carrying and using outdoor tents, transporting folded tents requires significant physical effort due to their substantial weight, resulting in inconvenience and negatively impacting the progress of outdoor activities, thereby diminishing consumer experience. Therefore, to address the shortcomings of the prior art, improvements to prior art are necessary.

### SUMMARY

The objective of the present disclosure is to overcome the shortcomings and deficiencies in the prior art and provide a tent support tube caster device with a simple structure and user-friendly operation.

The present disclosure is implemented through the following technical solution:

A tent support tube caster device includes a base and a caster mechanism, in which the base is mounted at a bottom of a tent support tube, the caster mechanism includes a caster bracket and a roller mounted on the caster bracket, the roller is disposed at a lateral side of the base, and the caster mechanism is connected to the base.

### BRIEF DESCRIPTION OF THE DRAWINGS

In order to illustrate the technical solutions of the embodiments of the present disclosure or of the prior art more clearly, the following drawings are briefly described as required in the context of the embodiments or the prior art. Obviously, the following drawings illustrate only some embodiments of the present disclosure. Other relevant drawings may be obtained on the basis of these drawings without any creative effort by those skilled in the art.

FIG. 1 is a schematic structural diagram of the tent support tube caster device of the present disclosure;

FIG. 2 is an exploded structural diagram of the tent support tube caster device of the present disclosure;

FIG. 3 is a schematic structural diagram of the base of the tent support tube caster device of the present disclosure;

FIG. 4 is a schematic structural diagram of the caster bracket of the tent support tube caster device of the present disclosure.

### DETAILED DESCRIPTION

The technical solutions in the embodiments of the present disclosure are clearly and completely described and discussed below in conjunction with the attached drawings of the embodiments of the present disclosure. Obviously, the embodiments described herein are only some embodiments of the present disclosure but not all of them. Based on the embodiments in the present disclosure, all other embodiments obtained by those skilled in the art without creative efforts fall within the scope of protection of the present disclosure.

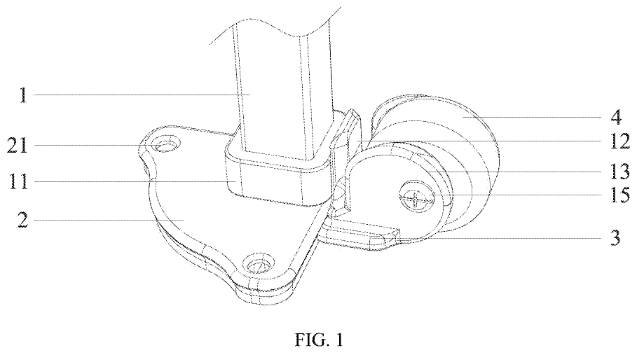

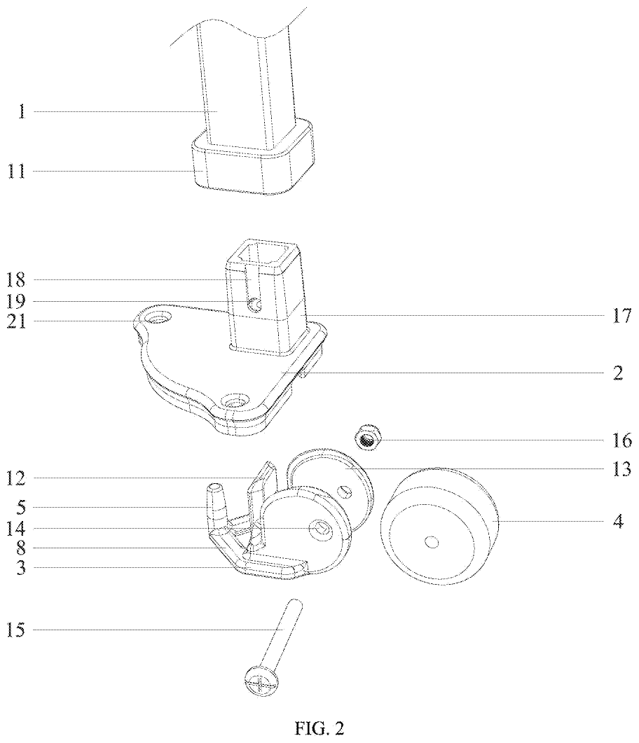

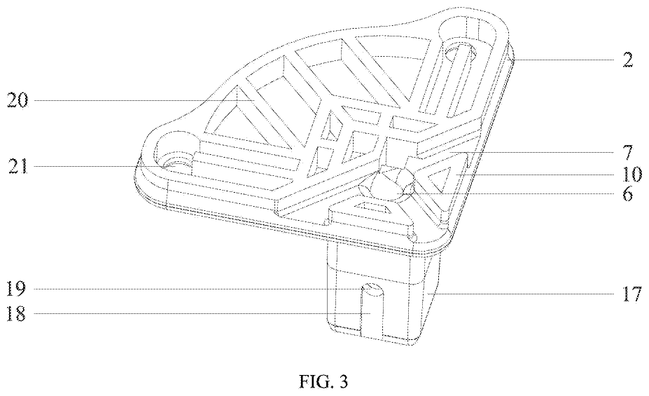

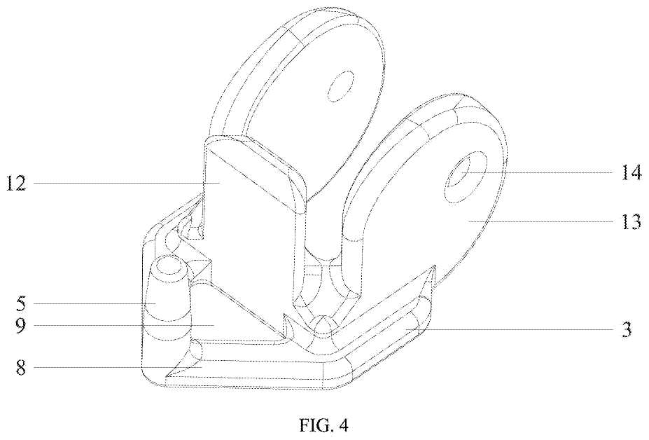

The tent support tube caster device of the present disclosure, as shown in FIGS. 1 to 4, includes a base 2 and a caster mechanism. The base 2 is mounted at a bottom of a tent support tube 1. The caster mechanism includes a caster bracket 3 and a roller 4 mounted on the caster bracket 3. The roller 4 is disposed at a lateral side of the base 2, and the caster mechanism is connected to the base 2. The caster device has a simple structure and facilitates convenient and quick installation. During packaging, since the caster mechanism is installed only during use, the caster mechanism is less likely to puncture cartons during transportation. During use, the caster mechanism is able to be quickly mounted to the base 2. When moving the folded tent, tilting the tent support tube 1 toward the roller 4 side to bring the roller 4 into contact with the ground allows dragging or pushing the folded tent with reduced physical effort, achieving convenient portability. During use, the base has a large contact area with the ground to ensure stable support of the tent, resulting in effective operational performance and enhanced consumer experience.

In this embodiment, the caster bracket 3 is detachably mounted to the base 2. As another specific implementation, the caster bracket 3 may also be integrally formed with the base 2.

The caster bracket 3 is snap-fit or plug-in connected to the base 2, enabling quicker and more convenient installation of the caster mechanism, while the caster bracket 3 may also be mounted to the base 2 via screws.

As another implementation, the caster bracket 3 is plug-in connected to the base 2. The caster bracket 3 is provided with an insertion post 5, and the base 2 is provided with an insertion hole 6 for receiving the insertion post 5. The insertion post 5 and the insertion hole 6 form an interference fit to achieve fixed connection between the caster bracket 3 and the base 2. The insertion post 5 has a tapered configuration with increasing diameter from top to bottom, facilitating stable insertion into the insertion hole 6 while gradually enhancing load-bearing capacity and connection stability. The insertion post 5 may be circular, square, or other shapes. A circular insertion post 5 enables easier insertion, whereas a square insertion post 5 effectively prevents rotation of the caster bracket 3. The insertion hole 6 is a cylindrical hole to ensure stable plug-in connection.

In this embodiment, the insertion post 5 is inserted from a bottom surface of the base 2. As another specific implementation, the insertion post 5 may also be inserted from a lateral surface of the base 2.

As another specific implementation, the caster bracket 3 is snap-fit connected to the base 2. The caster bracket 3 is provided with a snap hook, and the base 2 is provided with a snap groove corresponding to the snap hook, achieving fixed connection between the caster bracket 3 and the base 2. The snap hook may be fixed by snapping downward from an upper end of the base 2, upward from a lower end of the base 2, or laterally from opposing sides of the base 2.

The base 2 is provided with a positioning connection groove 7 at its bottom, and the caster bracket 3 is provided with a positioning connection block 8 corresponding to the positioning connection groove 7 at its top. The positioning connection groove 7 and the positioning connection block 8 enable rapid positioning installation and stable connection between the caster bracket 3 and the base 2. As a specific implementation, the positioning connection groove 7 is arranged in a T-shaped configuration; the base 2 has a right-triangular configuration; the positioning connection block 8 has a right-triangular configuration; an inner side of the positioning connection block 8 is provided with a right-triangular connection groove 9; and the bottom of the base 2 is provided with a right-triangular connection block 10 corresponding to the right-triangular connection groove 9. This allows the caster bracket 3 to be selectively installed on either side of a right-angled corner of the base 2 according to the actual usage direction of the roller 4, enhancing operational convenience. The shapes of the positioning connection groove 7 and the positioning connection block 8 may alternatively adopt square or other configurations.

The caster bracket is provided with an abutment plate 12. A side of the abutment plate 12 is subjected to a force from the base 2 or the tent support tube 1, while the roller 4 is disposed on an opposite side of the abutment plate 12. This configuration enhances the stability of the caster bracket 3 in supporting the base 2, ensures smoother dragging or pushing of the folded tent, and prevents excessive deformation of the caster bracket 3 under load.

As a specific implementation, a connection sleeve 11 is mounted on an outer side of a bottom of the tent support tube 1. The abutment plate 12 abuts against the connection sleeve 11, increasing the load-bearing area between the caster bracket 3 and the tent support tube 1. This reinforces the stability of the caster bracket 3 in supporting the base 2, improves the smoothness of tent relocation, and prevents deformation or fracture of the caster bracket 3 under stress. As another implementation, the base 2 is provided with a load-bearing plate at its outer edge. The abutment plate 12 abuts against the load-bearing plate, enhancing the operational stability of the caster bracket 3.

The caster bracket 3 is provided with a mounting guard plate 13 for installing the roller 4. The mounting guard plate 13 is provided with a screw mounting hole 14. The roller 4 is mounted to the mounting guard plate 13 via a screw 15 and a locknut 16, enabling rapid and secure installation. The mounting guard plate 13 is contoured to match a lateral profile of the roller 4, effectively shielding the roller 4 from external impacts.

The base 2 is provided with a sleeve column 17 at its top for sleeved installation of the tent support tube 1, facilitating stable assembly of the base 2 onto the tent support tube 1. The insertion post 5 is inserted into an inner side of the sleeve column 17, enhancing connection stability of the insertion post 5 and ensuring secure installation of the caster bracket 3.

The sleeve column 17 has a tapered configuration with increasing diameter from top to bottom, promoting stable engagement with the tent support tube 1 while progressively strengthening load-bearing capacity and connection rigidity. The upper portion of the sleeve column 17 is provided with a connection groove 18 and a connection hole 19. The connection hole 19 allows the sleeve column 17 to be secured to the tent support tube 1 via connection screws, nails, or positioning pins for reinforced stability, while the connection groove 18 facilitates guided installation of the sleeve column 17, ensuring precise alignment of the base 2.

The base 2 is provided with reinforcing ribs 20 at its bottom to reduce production costs and enhance structural strength. The base 2 is further provided with bolt mounting holes 21, enabling fixed installation to the ground via bolts.

A bottom surface of the base 2 is coplanar with a bottom surface of the caster bracket 3, and a bottom surface of the roller 4 is coplanar with the bottom surface of the caster bracket 3. During use, the base 2, caster bracket 3, and roller 4 simultaneously contact the ground, improving tent support stability and operational effectiveness.

Both the base 2 and caster bracket 3 are fabricated as plastic components, offering low manufacturing costs, ease of installation, and durable performance.

In some implementations, the caster bracket is snap-fit or plug-in connected to the base.

In some implementations, the caster bracket is provided with an insertion post, the base is provided with an insertion hole for receiving the insertion post, and the insertion post and the insertion hole form an interference fit.

In some implementations, a positioning connection groove is formed at a bottom of the base, and the caster bracket is provided with a positioning connection block corresponding to the positioning connection groove.

In some implementations, the positioning connection groove is arranged in a T-shaped configuration; the base has a right triangular configuration; the positioning connection block has a right triangular configuration; an inner side of the positioning connection block is provided with a right-triangular connection groove; and the bottom of the base is provided with a right-triangular connection block corresponding to the right-triangular connection groove.

In some implementations, the caster bracket is provided with an abutment plate, a side of the abutment plate is subjected to a force from the base or the tent support tube, and the roller is disposed on an opposite side of the abutment plate.

In some implementations, a connection sleeve is mounted on an outer side of a bottom of the tent support tube, and the abutment plate abuts against the connection sleeve.

In some implementations, the caster bracket is provided with a mounting guard plate for mounting the roller, the mounting guard plate is provided with a screw mounting hole, and the roller is mounted to the mounting guard plate via a screw and a locknut.

In some implementations, the base is provided with a sleeve column for sleeved installation of the tent support tube, an upper portion of the sleeve column has a gradually increasing diameter from top to bottom, and the upper portion of the sleeve column is provided with a connection groove and a connection hole.

In some implementations, a bottom surface of the base is coplanar with a bottom surface of the caster bracket, and a bottom surface of the roller is coplanar with the bottom surface of the caster bracket.

Compared with the prior art, according to the present disclosure, the caster mechanism includes the caster bracket and the roller mounted on the caster bracket, in which the roller is disposed at a lateral side of the base, and the caster mechanism is connected to the base. The above enables the caster device to have a simple structure and convenient and quick installation; during packaging, since the caster mechanism is installed only during use, the caster mechanism is less likely to puncture cartons during transportation; during use, the caster mechanism can be quickly installed to the base; when moving the folded tent, tilting the tent support tube to bring the roller into contact with the ground allows dragging or pushing the folded tent with reduced physical effort, providing convenient portability; during use, the base has a large contact area with the ground to ensure stable support of the tent, resulting in effective performance and enhanced consumer experience.

The foregoing embodiments represent preferred implementations of the present disclosure and are not intended to limit its scope. Any modifications, equivalent substitutions, or improvements made within the spirit and principles of the disclosure shall fall within the protection scope of the present disclosure.

Labels: 1 tent support tube; 2 base; 3 caster bracket; 4 roller; 5 insertion post; 6 insertion hole; 7 positioning connection groove; 8 positioning connection block; 9 right-triangular connection groove; 10 right-triangular connection block; 11 connection sleeve; 12 abutment plate; 13 mounting guard plate; 14 screw mounting hole; 15 screw; 16 locknut; 17 sleeve column; 18 connection groove; 19 connection hole; 20 reinforcing rib; 21 bolt mounting hole.

1. A tent support tube caster device, comprising a base and a caster mechanism, wherein the base is mounted at a bottom of a tent support tube, the caster mechanism comprises a caster bracket and a roller mounted on the caster bracket, the roller is disposed at a lateral side of the base, and the caster mechanism is connected to the base.

2. The tent support tube caster device according to claim 1, wherein the caster bracket is snap-fit or plug-in connected to the base.

3. The tent support tube caster device according to claim 1, wherein the caster bracket is provided with an insertion post, the base is provided with an insertion hole for receiving the insertion post, and the insertion post and the insertion hole form an interference fit.

4. The tent support tube caster device according to claim 1, wherein a positioning connection groove is formed at a bottom of the base, and the caster bracket is provided with a positioning connection block corresponding to the positioning connection groove.

5. The tent support tube caster device according to claim 4, wherein the positioning connection groove is arranged in a T-shaped configuration; the base has a right triangular configuration; the positioning connection block has a right triangular configuration; an inner side of the positioning connection block is provided with a right-triangular connection groove; and the bottom of the base is provided with a right-triangular connection block corresponding to the right-triangular connection groove.

6. The tent support tube caster device according to claim 1, wherein the caster bracket is provided with an abutment plate, a side of the abutment plate is subjected to a force from the base or the tent support tube, and the roller is disposed on an opposite side of the abutment plate.

7. The tent support tube caster device according to claim 6, wherein a connection sleeve is mounted on an outer side of a bottom of the tent support tube, and the abutment plate abuts against the connection sleeve.

8. The tent support tube caster device according to claim 1, wherein the caster bracket is provided with a mounting guard plate for mounting the roller, the mounting guard plate is provided with a screw mounting hole, and the roller is mounted to the mounting guard plate via a screw and a locknut.

9. The tent support tube caster device according to claim 1, wherein the base is provided with a sleeve column for sleeved installation of the tent support tube, an upper portion of the sleeve column has a gradually increasing diameter from top to bottom, and the upper portion of the sleeve column is provided with a connection groove and a connection hole.

10. The tent support tube caster device according to claim 1, wherein a bottom surface of the base is coplanar with a bottom surface of the caster bracket, and a bottom surface of the roller is coplanar with the bottom surface of the caster bracket.
